(19) United States
(12) Patent Application Publication
(10) Pub. No.: US 2006/0259337 A1
(43) Pub. Date: Nov. 16, 2006

(54) System and method for managing business partner qualifications

(76) Inventors: Boris Bierbaum, Mannheim (DE); Hermann Josef Duengelhoef, Mannheim (DE); Pramodh Kumar Kapoor, Bangalore (IN); Oliver G. Strauch, Schwetzingen (DE)

Correspondence Address: KENYON & KENYON, 1500 K STREET N.W., WASHINGTON, DC, 20005, US

(21) Appl. No.: 11/127,212

(22) Filed: May 12, 2005

(51) Int. Cl. G06F 17/60; G06K 9/00

(52) U.S. Cl. 705/7

(57) ABSTRACT

A system and method for managing business partner qualifications. According to one embodiment, an application receives a request by an external business partner to assign a qualification to an entity associated with the external business partner, determines whether the qualification is authorized for direct assignment by the external business partner, and assigns the qualification to the entity if the qualification is determined to be authorized for direct assignment by the external business partner. According to another embodiment, an application receives a request to search qualification data associated with an entity associated with an external business partner, executes a search for the qualification data in response to the request, and provides results of the search. According to yet another embodiment, a data structure comprises one or more data elements identifying a qualification type associated with an external business partner and one or more data elements associating a qualification value with the qualification type.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

Current channel management solutions (such as mySAP CRM Channel Management) allow brand owners to manage their indirect partner channel—i.e., independently operating channel partners that market, sell and/or service the brand owner's products. For those business partners, a partner portal provides access to data and processes of the brand owner's Customer Relationship Management (“CRM”) system.

Prior to the present invention, however, it has not been possible to store information about a channel partner's skill set and competencies. Because of this, brand owners have not been able to find the best-fit channel partner and partner employee for a “job” (e.g., processing a forwarded sales lead or opportunity), nor plan necessary trainings and programs for its business partners.

Accordingly, there is a need in the art for a system and method for managing business partner qualifications.

### BRIEF DESCRIPTION OF THE DRAWINGS

FIG. 1 is a process flow diagram that depicts the management of a qualification assignment request in accordance with an embodiment of the present invention.

FIG. 2 is a process flow diagram that depicts the management of another qualification assignment request in accordance with an embodiment of the present invention.

FIGS. 3A through 3E are block diagrams that depict data structures associated with qualification assignments in accordance with an embodiment of the present invention.

FIG. 4 is a screenshot that depicts a company profile screen from which a request for a qualification may be launched in accordance with an embodiment of the present invention.

FIG. 5 is a screenshot that depicts a contact persons screen from which a request for a qualification may be launched in accordance with an embodiment of the present invention.

FIG. 6 is a screenshot that depicts an input screen for a qualification assignment request in accordance with an embodiment of the present invention.

FIG. 7 is a process flow diagram that depicts the management of a qualification search request in accordance with an embodiment of the present invention.

FIG. 8 is a screenshot that depicts a contact persons screen from which a qualification search request may be launched in accordance with an embodiment of the present invention.

FIG. 9 is a screenshot that depicts an input screen in which a qualifications catalog search request may be launched in accordance with an embodiment of the present invention.

FIG. 10 is a block diagram that depicts a computing device in accordance with an embodiment of the present invention.

### DETAILED DESCRIPTION

The present invention addresses the current drawbacks in channel management by providing for the assignment of qualifications (e.g., a skill, knowledge, or ability of a business partner, such as “consulting experienced and their corresponding proficiencies (e.g., describing the level of qualification, such as “advanced”) to business partners and their employees. Unlike the existing concept of qualifications, which up to now was exclusively utilized to model internal employees of a company, the present invention greatly enhances the management of channel partners by extending this concept to external business partners.

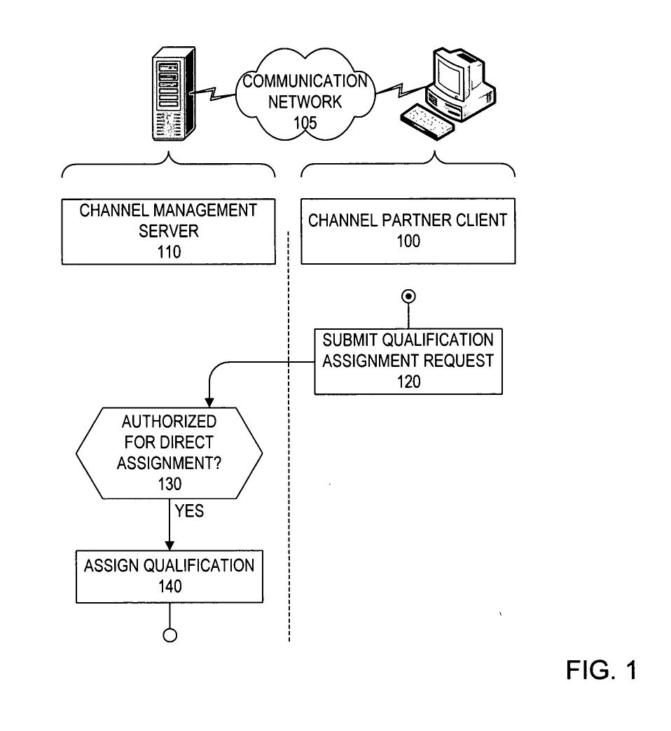

In order for a brand owner to know about its channel partners' qualifications, the present invention enables the channel partners themselves to request the assignment of qualifications pertaining to their company and/or their employees, as illustrated in FIG. 1. In this embodiment, a channel partner utilizes channel partner client 100 to submit a qualification assignment request to channel management server 110, which is operated by a brand owner (step 120). Server 110 determines whether the qualification is authorized for direct assignment by the channel partner (step 130), and if so, proceeds with the assignment (step 140). The assignment may include changing a proficiency of a qualification previously assigned to an entity (e.g., data structure) associated with the external business partner.

Since it may not be desired for a brand owner to grant unrestricted access to all qualifications in the brand owner's system, the present invention enables the brand owner to require a certain subset of qualifications to be explicitly approved or rejected by an internal channel manager. For example, a channel manager of a brand owner may want to differentiate between qualifications that a channel partner should be able to assign without the channel manager's explicit approval (e.g., “Spanish language knowledge”) as opposed to qualifications that should require the channel manager's explicit approval (e.g., “certified CRM consultants.

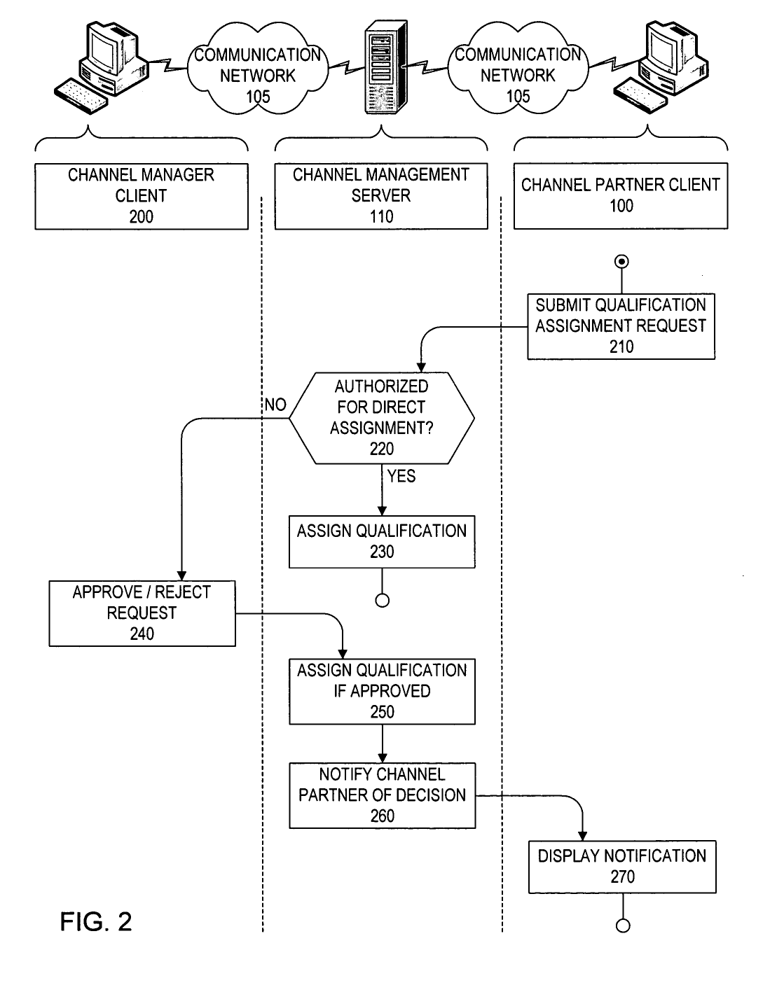

This embodiment is illustrated in FIG. 2, in which steps 210, 220 and 2230 are identical to steps 120, 130 and 140 of FIG. 1. However, if server 110 determines that a qualification is not authorized for direct assignment by the channel partner, it forwards the request to channel manager client 200 (operated, e.g., by an internal channel manager of the brand owner) for approval or rejection (step 240). If the request is approved, server 110 assigns the qualification (step 250). Server 110 notifies channel partner client 100 of the channel manager's decision (step 260), which is displayed at client 100 (step 270).

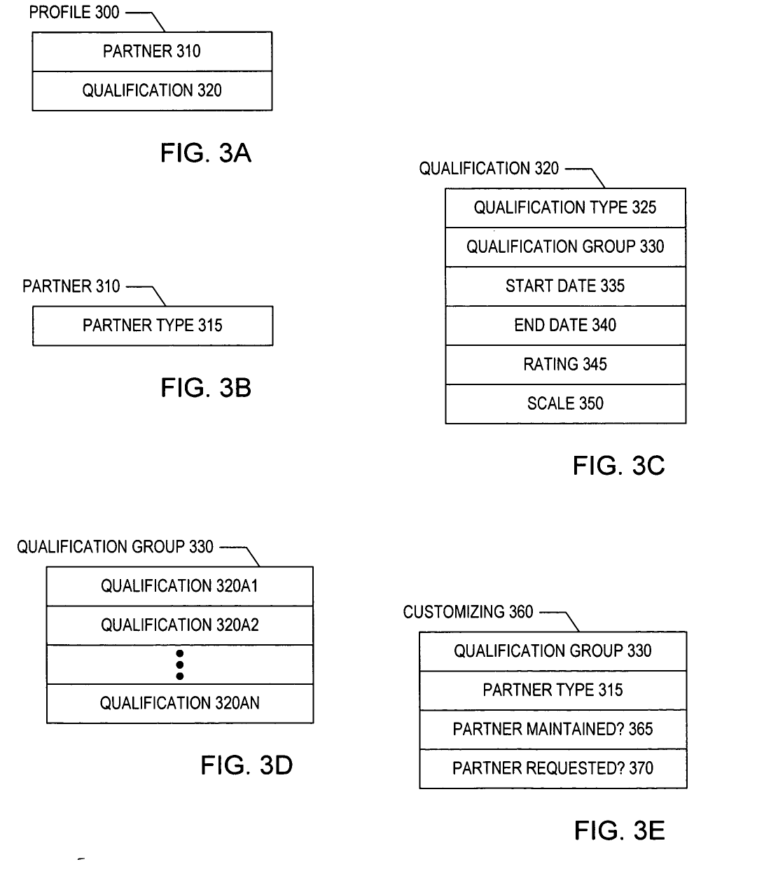

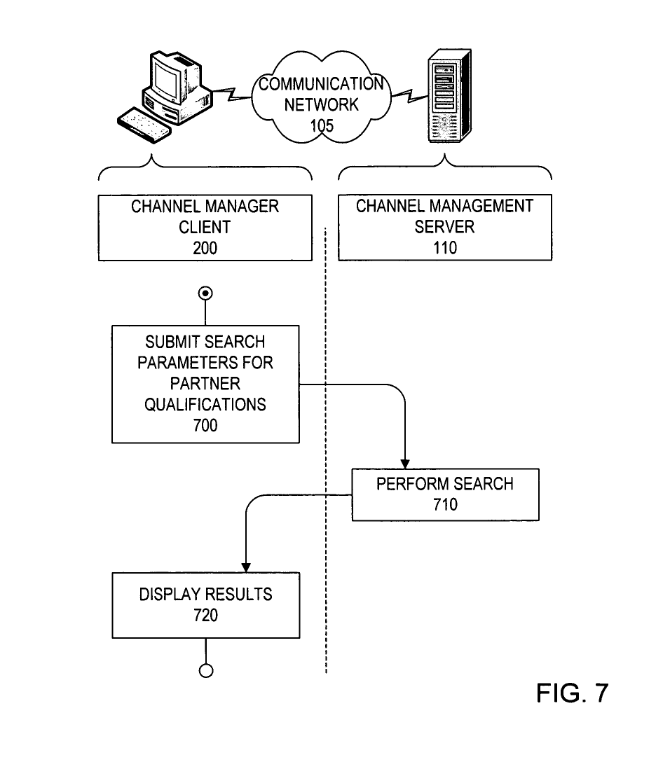

FIGS. 3A-3E depict data structures that may be utilized in the implementation of partner qualification management in accordance with an embodiment of the present invention. For instance, FIG. 3A illustrates a profile (data structure 300) in which qualification information (320) may be associated with a channel partner (310). This association enables server 110 to implement the qualification assignments in steps 140 and 250, and the searching functionality to be discussed below in reference to FIGS. 7-9.

As shown in FIG. 3B, partner 310 may include a partner type (315) that identifies whether the partner entity represents the business partner at a company level or at an employee level.

As shown in FIG. 3C, qualification 320 may include a qualification type (325) that identifies the nature of the qualification (e.g., “Spanish language knowledge”), a qualification group (330) that identifies a classification for grouping similar qualifications together (e.g., “language knowledge”), a start date (335) and end date (340) that identifies a temporal limitation associated with the qualification (e.g., when a certification must be renewed), a rating (345) that identifies a proficiency level associated with the qualification (e.g., “advanced”), and a scale (350) that identifies proficiency levels associated with the rating.

A qualification group (330) may simply comprise a grouping of one or more qualifications (320A1 . . . AN), as illustrated in FIG. 3D.

FIG. 3E illustrates a data structure (360) that may be allow a channel manager, for example, to customize which qualifications (or, more specifically in this embodiment, which groups of qualifications) are to be maintained by a channel partner (thus not requiring explicit approval by the channel manager) as opposed to which qualifications require explicit approval by the channel manager. The customizing data structure (360) may include a qualification group (330), partner type (315), a field (365) that identifies if the partner maintains the qualification information, and a field (370) that identifies if the partner must request the qualification information from a channel manager. This data structure (360) enables server 110 to implement the authorization determination in steps 130 and 220.

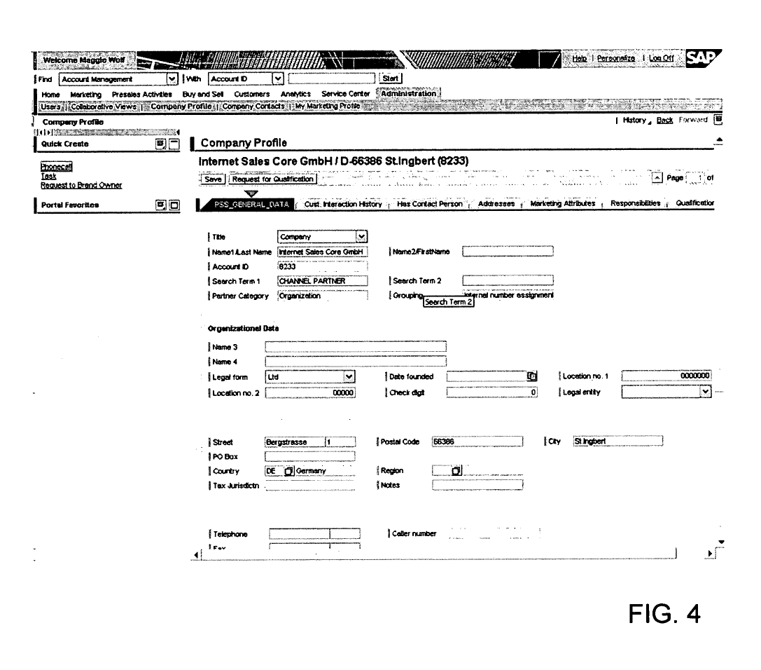

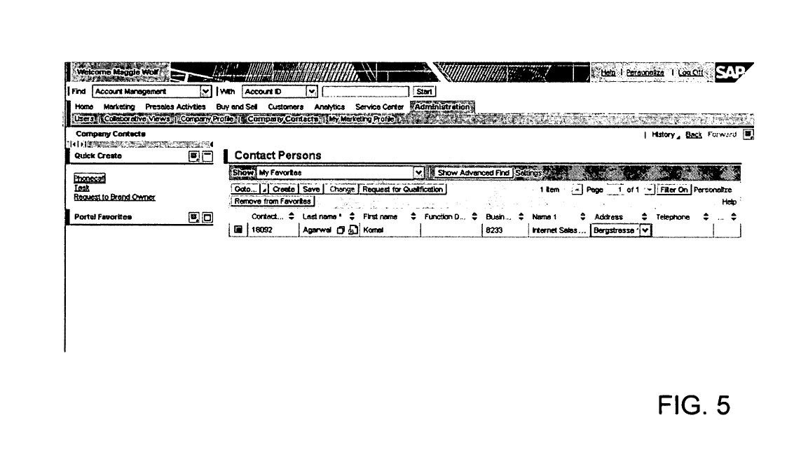

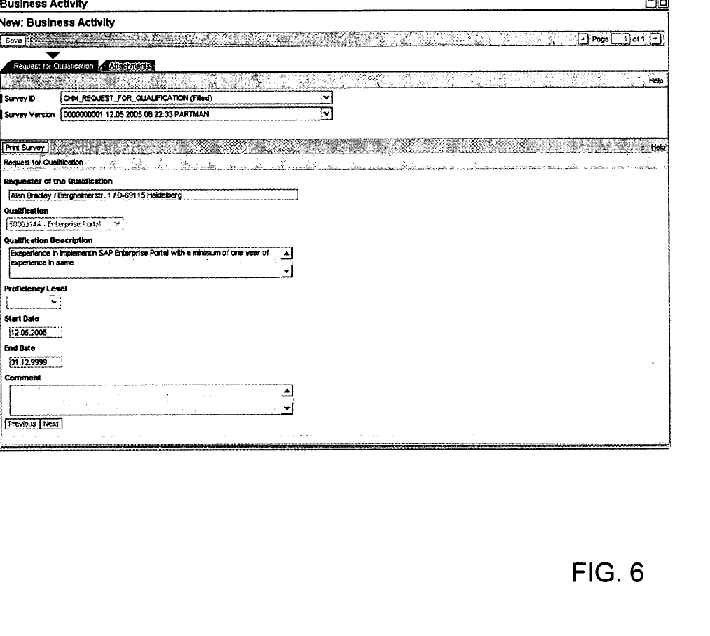

FIG. 4 depicts a company profile screen from which a request for a qualification may be launched in accordance with an embodiment of the present invention. If a channel partner desires to assign a qualification at the company level, the channel partner could click on the “Request for Qualification” button in the toolbar and an input screen for a qualification assignment request may be exposed as illustrated in FIG. 6. This input screen would enable the channel partner to enter a qualification, proficiency level and other information desired to be associated with the company associated with the channel partner. If the channel partner desires to assign a qualification at the employee level, the channel partner could click on the “Request for Qualification” button in the toolbar of the contact persons profile screen shown in FIG. 5, and enter the desired qualification information into the subsequently exposed assignment request form of FIG. 6.

In order for a channel manager to gain the full benefit of the channel partner qualification information (e.g., processing a forwarded sales lead or opportunity), the present invention enables the channel manager to search the qualification information as illustrated in FIG. 7. In this embodiment, channel manager client 200 submits search parameters based on partner qualification information (step 700). Server 110 performs the search (step 710) by querying the qualification information for any matches, and displays the results on channel manager client (step 720).

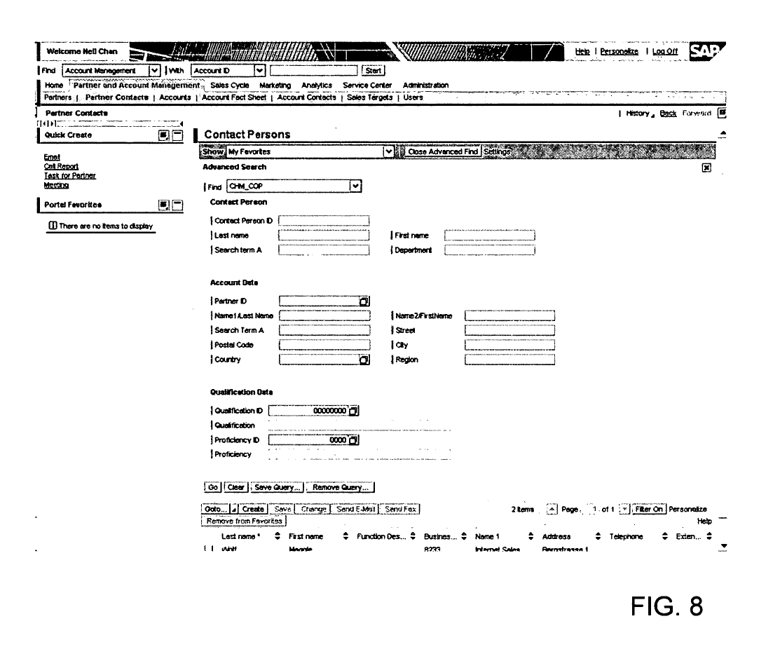

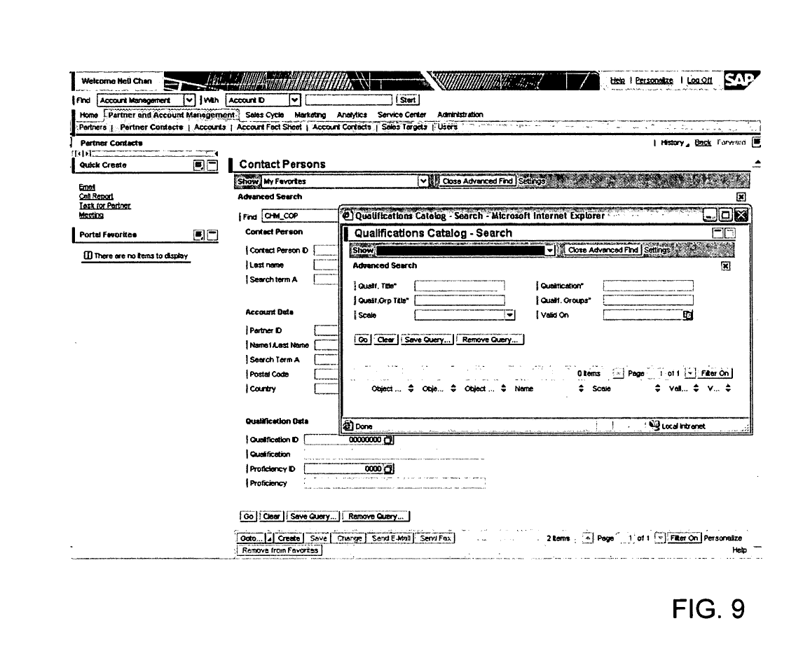

FIG. 8 depicts a contact persons screen from which a qualification search request may be launched in accordance with an embodiment of the present invention. In this embodiment, the searchable fields include the qualification (320) and proficiency (345). FIG. 9 depicts an input screen in which a qualifications catalog search request may be launched in accordance with an embodiment of the present invention. In this embodiment, the searchable fields include the qualification (320), qualification group (330), scale (350) and valid date (falling within start date 335 and end date 340).

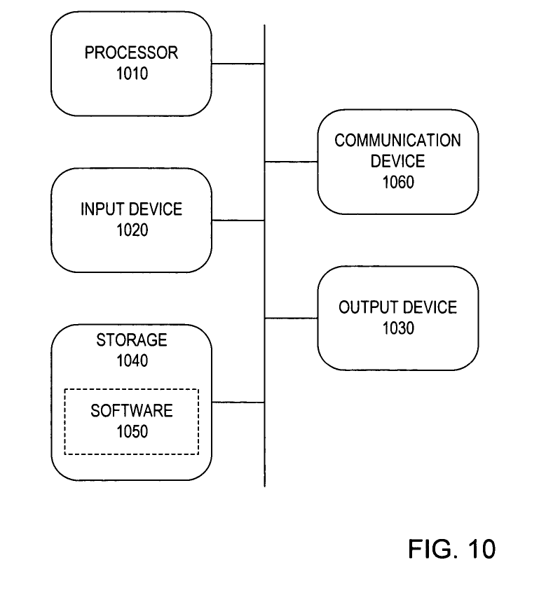

FIG. 10 illustrates the components of a basic computing device in accordance with an embodiment of the present invention, which may include client 100, server 110 and client 200. The computing device may be a personal computer, workstation, handheld personal digital assistant (“PDA”), or any other type of microprocessor-based device. The computing device may include one or more of processor 1010, input device 1020, output device 1030, storage 1040, and communication device 1060.

Input device 1020 may include a keyboard, mouse, pen-operated touch screen or monitor, voice-recognition device, or any other device that provides input. Output device 1030 may include a monitor, printer, disk drive, speakers, or any other device that provides output.

Storage 1040 may include volatile and nonvolatile data storage, including one or more electrical, magnetic or optical memories such as a RAM, cache, hard drive, CD-ROM drive, tape drive or removable storage disk. Communication device 1060 may include a modem, network interface card, or any other device capable of transmitting and receiving signals over a network. The components of the computing device may be connected via an electrical bus or wirelessly.

Software 1050, which may be stored in storage 1040 and executed by processor 1010, may include, for example, the application programming that embodies the functionality of the present invention (e.g., as embodied in mySAP CRM 5.0). Software 1050 may include a combination of enterprise servers such as an application server and a database server.

Network 105 may include any type of interconnected communication system, which may implement any communications protocol, which may be secured by any security protocol. The corresponding network links may include telephone lines, DSL, cable networks, T1 or T3 lines, wireless network connections, or any other arrangement that implements the transmission and reception of network signals.

The computing device may implement any operating system, such as Windows or UNIX. Software 1050 may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention. For example, the data structures that implement the present invention can take many different forms yet still provide the same functionality.

What is claimed is:

1. A computer-implemented method for managing business partner qualifications, comprising:
receiving a request by an external business partner to assign a qualification to an entity associated with the external business partner;
determining whether the qualification is authorized for direct assignment by the external business partner; and
assigning the qualification to the entity if the qualification is determined to be authorized for direct assignment by the external business partner.

2. The method of claim 1, wherein the request is received by process implemented by a brand owner, and the external business partner is a channel partner of the brand owner operating independently of the brand owner and marketing, selling or servicing products of the brand owner.

3. The method of claim 1, wherein the request to assign the qualification includes a request to change a proficiency of a qualification previously assigned to the entity.

4. The method of claim 1, wherein the entity represents the external business partner at a company level.

5. The method of claim 1, wherein the entity represents the external business partner at an employee level.

6. The method of claim 1, wherein the entity is a database table.

7. The method of claim 1, wherein the qualification includes a skill associated with the external business partner.

8. The method of claim 1, wherein the qualification includes a knowledge associated with the external business partner.

9. The method of claim 1, wherein the qualification includes an ability associated with the external business partner.

10. The method of claim 1, further comprising:
forwarding the request for approval or rejection by an internal manager if the qualification is determined to be unauthorized for direct assignment by the external business partner;
assigning the qualification to the entity if the request is approved by the internal manager.

11. A computer-implemented method for searching business partner qualifications, comprising:
receiving a request to search qualification data associated with an entity associated with an external business partner;
executing a search for the qualification data in response to the request; and
providing results of the search.

12. The method of claim 11, wherein the request is received by process implemented by a brand owner, and the external business partner is a channel partner of the brand owner operating independently of the brand owner and marketing, selling or servicing products by the brand owner.

13. The method of claim 11, wherein the entity is a database table.

14. The method of claim 11, wherein the qualification data includes a skill associated with the external business partner.

15. The method of claim 11, wherein the qualification data includes a knowledge associated with the external business partner.

16. The method of claim 11, wherein the qualification data includes an ability associated with the external business partner.

17. A data structure to manage business partner qualifications, the data structure comprising:
one or more data elements identifying an external business partner; and
one or more data elements identifying a qualification associated with the external business partner.

18. The data structure of claim 17, wherein the qualification includes a skill associated with the external business partner.

19. The data structure of claim 17, wherein the qualification includes a knowledge associated with the external business partner.

20. The data structure of claim 17, wherein the qualification includes an ability associated with the external business partner.

21. The data structure of claim 17, wherein the qualification includes a proficiency rating.

22. The data structure of claim 17, wherein the qualification includes a proficiency scale.

23. The data structure of claim 17, wherein the qualification includes a start date or end date.
